(19) United States
(12) Patent Application Publication
(10) Pub. No.: US 2008/0218463 A1
(43) Pub. Date: Sep. 11, 2008

(54) DISPLAY DEVICE AND METHOD FOR DRIVING THE SAME

(75) Inventors: Jun-Woo LEE, Anyang-si (KR); Hee-Seop KIM, Hwaseong-si (KR); Hong-Jo PARK, Suwon-si (KR); Eun-Hee HAN, Seoul (KR); Seung-Hoon LEE, Yongin-si (KR); Sung-Jae YUN, Yongin-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/032,152

(22) Filed: Feb. 15, 2008

(30) Foreign Application Priority Data
Mar. 9, 2007 (KR) 10-2007-0023379

(51) Int. Cl. G09G 3/36

(52) U.S. Cl. 345/89

(57) ABSTRACT

A display device and a method for driving the same are disclosed. The display device driving method includes applying a first gray scale display voltage according to a first gamma curve to a liquid crystal layer during a first sub-frame period and applying a second gray scale display voltage according to a second gamma curve to the liquid crystal layer during a second sub-frame period. The first and second gamma curves are discontinuous at one or more gray scale values among all gray scale regions.

### CROSS REFERENCE TO RELATED APPLICATION

This application claims priority from and the benefit of Korean Patent Application No. 10-2007-0023379, filed on Mar. 9, 2007, which is hereby incorporated by reference for all purposes set forth herein.

### BACKGROUND OF THE INVENTION

1. Field of Invention

The present invention relates to a display device and a method for driving the same, and more particularly, to a display device which is driven in an impulsive method and a method for driving the same.

2. Discussion of the Background

A typical liquid crystal display (LCD) device includes a thin film transistor (TFT) substrate having a pixel electrode and a color filter substrate having a common electrode with a liquid crystal layer interposed therebetween. In an LCD device, an electric field forms when a pixel voltage is applied to a pixel electrode and a common voltage is applied to a common electrode, which causes the alignment of the liquid crystal in the liquid crystal layer to change, thereby adjusting the light transmittance and displaying an image.

Unlike a cathode ray tube (CRT), which is driven in an impulsive method, an LCD device is driven in a hold-type method and therefore may have a motion blur phenomenon in which an image is transformed according to the direction in which the image moves.

In order to prevent the motion blur phenomenon in an LCD device, an impulsive driving method that inserts black data or uses a blinking backlight and a method for speeding up a frame rate may be used.

The impulsive driving method is attracting attention because it can be realized by changing a control signal of an LCD device. Particularly, if an impulsive driving method, which inserts black data, is applied to an LCD in an optically compensated bend (OCB) mode, the bent state may be maintained at a voltage lower than a threshold voltage and the visibility of a moving picture may be improved.

However, a flicker may occur due to a significant luminance difference between black data and display data.

### SUMMARY OF THE INVENTION

The present invention provides a display device that is driven in an impulsive method using different gamma curves according to a data gray scale and a method for driving the same.

Additional features of the invention will be set forth in the description which follows, and in part will be apparent from the description, or may be learned by practice of the invention.

The present invention discloses a display device driving method including applying a first gray scale display voltage according to a first gamma curve to a liquid crystal layer during a first sub-frame period and applying a second gray scale display voltage according to a second gamma curve to the liquid crystal layer during a second sub-frame period. The first and second gamma curves are discontinuous at one or more gray scale values among all gray scale regions.

The present invention also discloses a display device including a frame storing portion, a gamma storing portion, a timing controller, and a data driver. The frame storing portion receives and stores raw data input at a first driving frequency and the gamma storing portion stores first and second gamma information. The timing controller generates processing data based on the raw data stored in the frame storing portion and the first and second gamma information stored in the gamma storing portion and the data driver receives the processes data from the timing controller and applies a gray scale display voltage to a pixel capacitor of a display panel. A first gamma curve corresponding to the first gamma information and a second gamma curve corresponding to the second gamma information are discontinuous at one or more gray scale values among all gray scale regions. The timing controller synchronizes the processing data according to the first gamma information with a second driving frequency during a first sub-frame period and synchronizes the processing data according to the second gamma information with the second driving frequency during a second sub-frame period.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a display device according to an exemplary embodiment of the present invention

FIG. 2 is a graph showing a relationship of a gray scale display voltage and transmittance of the display device of FIG. 1.

FIG. 3 is a block diagram showing a timing controller according to the exemplary embodiment of the present invention.

FIG. 4 is a block diagram showing a data driver according to the exemplary embodiment of the present invention.

FIG. 5 is a graph showing a type of gamma curves to be stored in a gamma storing portion according to the exemplary embodiment of the present invention.

FIG. 6 is a graph showing another type of gamma curves to be stored in the gamma storing portion.

FIG. 7 is a graph showing new gamma information generated by using the type of gamma curve of FIG. 6.

FIG. 8 is a flowchart showing a display device driving method according to the exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

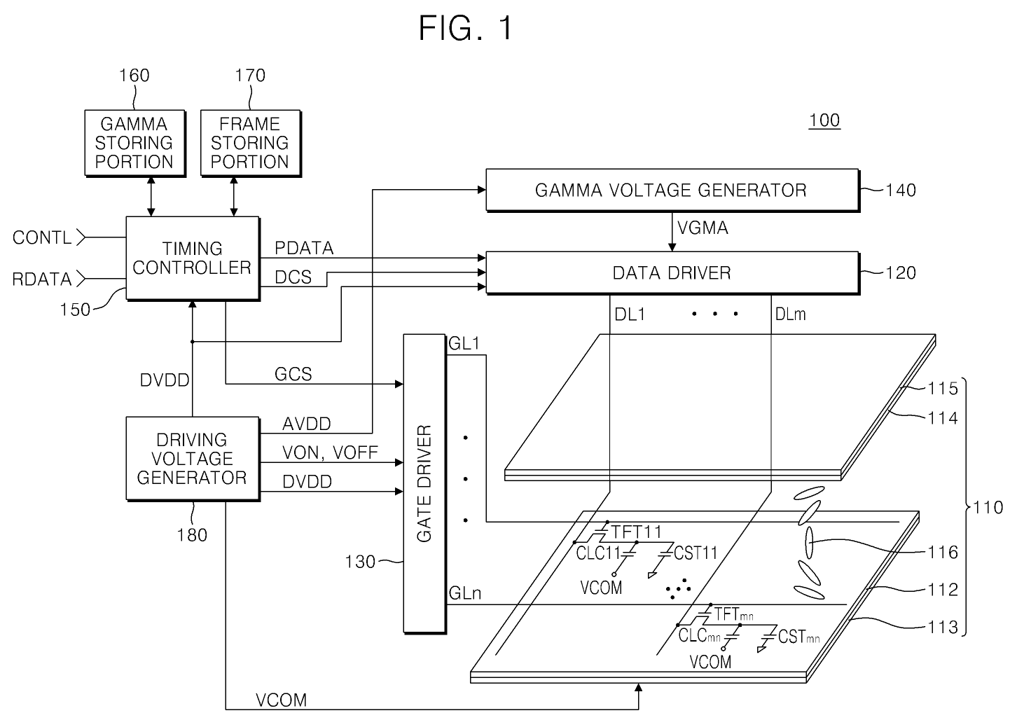

FIG. 1 is a block diagram showing a display device according to an exemplary embodiment of the present invention. As shown in FIG. 1, the display device 100 includes a display panel 110, a data driver 120, a gate driver 130, a gamma voltage generator 140, a timing controller 150, a gamma storing portion 160, a frame storing portion 170, and a driving voltage generator 180. The display panel 110 may operate in an impulsive driving method in an optically compensated bend (OCB) mode.

The display panel 110 includes a color filter substrate 114 having a color filter (not shown), a common electrode (not shown), and a first polarizer plate 115, a thin film transistor (TFT) substrate 112 having a TFT and a second polarizer plate 113, and a liquid crystal layer 116 interposed between the color filter substrate 114 and the TFT substrate 112. The first polarizer plate 115 and the second polarizer plate 113 are arranged on the color filter substrate 114 and the TFT substrate 112, respectively, so that their polarization axes are perpendicular to each other.

The TFT substrate 112 includes a plurality of pixel capacitors CLC11 to CLCmn, a plurality of TFTs for applying a gray scale display voltage to a plurality of pixel capacitors CLC11 to CLCmn in response to a gate on voltage VON, and a plurality of storage capacitors CST11 to CSTmn respectively connected in parallel to a plurality of pixel capacitors CLC11 to CLCmn to maintain a gray scale display voltage, which are formed at points where a plurality of gate lines GL1 to GLn cross a plurality of data lines DL1 to DLn.

Each TFT TFT11 to TFTmn includes a gate, a source, and a drain. For example, the TFT TFT11 includes a gate connected to the gate line GL1, a source connected to the data line DL1, and a drain connected to a pixel electrode of the pixel capacitor CLC11. A gray scale display voltage includes a first gray scale display voltage according to first gamma information and a second gray scale display voltage according to second gamma information. The first gray scale display voltage and the second gray scale display voltage are sequentially supplied to the pixel capacitors CLC11 to CLCmn during one frame. One frame includes a first sub-frame during which the first gray scale display voltage is applied and a second sub-frame during which the second gray scale display voltage is applied.

The liquid crystal in the liquid crystal layer 116 may operate in an OCB mode that uses a bent state as an initial driving state. To this end, nematic liquid crystal positive dielectric constant anisotropy may be used. An alignment layer is arranged on both the common electrode of the color filter substrate 114 and the pixel electrode of the TFT substrate 111, and then the alignment layers are rubbed in a direction that may form an angle of about 35° to about 55°, or about 125° to about 145°, with the polarization axis of the first polarizer plate 115 in order to splay-align the liquid crystal.

A voltage greater than a threshold voltage Vc is applied to the pixel electrode and the common electrode to convert the liquid crystal into a bent state, and then light transmittance is controlled by controlling an applied voltage. The threshold voltage Vc is the minimum voltage that maintains a bent state of the liquid crystal.

Alternatively, the liquid crystal in the liquid crystal layer 116 may be vertically aligned in the absence of an electric field and may have negative dielectric constant anisotropy. Other optical structures for an OCB mode are well known to a person having ordinary skill in the art, and a detailed description thereof omitted.

The data driver 120 generates a gray scale display voltage, which corresponds to a gray scale of processing data PDATA, using a reference gamma voltage VGMA and applies the gray scale display voltage to the pixel capacitors CLC11 to CLCmn of the display panel in a gate line (GL1 to GLn) unit through a plurality of TFTs TFT11 to TFTmn driven by the gate on voltage VON.

To this end, the data driver 120 receives a data control signal DCS and the processing data PDATA from the timing controller 150 and receives the reference gamma voltage VGMA from the gamma voltage generator 140.

In more detail, the data driver 120 receives processing data PDATA based on the first gamma information from the timing controller 150 to generate the first gray scale display voltage during the first sub-frame period and receives processing data PDATA based on the second gamma information from the timing controller 150 to generate the second gray scale display voltage during the second sub-frame period.

The data driver 120 may include a plurality of data driving integrated circuits (ICs) connected to the display panel 110 in a tape carrier package (TCP) form, or may be mounted onto the TFT substrate 112 of the display panel 110 in a chip on glass (COG) form, or may be integrated directly on the TFT substrate 112 using a poly crystalline silicon TFT.

The gate driver 130 sequentially applies the gate on voltage VON to the gate lines GL1 to GLn and the gate off voltage VOFF to a gate line to which the gate on voltage VON is not applied. That is, the gate driver 130 simultaneously turns on a plurality of TFTs respectively connected to the sequentially selected gate lines GL1 to GLn.

To this end, the gate driver 130 receives a gate control signal GCS from the timing controller 150 and receives the gate on voltage VON and the gate off voltage VOFF from the driving voltage generator 180.

The gate driver 130 may include a plurality of gate driving ICs connected to the TFT substrate 112 in a TCP form, or may be mounted onto the TFT substrate 112 in a COG form, or may be integrated on a non-display region of the TFT substrate 112 in an amorphous silicon gate form when the TFT is formed.

The gamma voltage generator 140 divides an analog power voltage AVDD supplied from the driving voltage generator 180 to generate the reference gamma voltage VGMA and provides it to the data driver 120.

The timing controller 150 receives raw data RDATA externally input, converts the raw data RDATA into processing data PDATA in consideration of the kind and number of driver ICs that constitute the gate driver 130 and the data driving potion 120, and provides the processing data PDATA to the data driver 120. The processing data PDATA is generated based on the first gamma information during the first sub-frame and based on the second gamma information during the second sub-frame.

The timing controller 150 generates the data control signal DCS and the gate control signal GCS using a control signal CONTL that is externally input and provides the data control signal DCS and the gate control signal GCS to the data driver 120 and the gate driver 130, respectively.

The control signal CONTL that is externally input may include a vertical synchronous signal, a horizontal synchronous signal, a main clock signal, and a driving mode selecting signal. The driving mode selecting signal may be provided to the timing controller 150 through a receiver by a user interface, such a remote control. The driving mode selecting signal is used to select one of a display device driving method according to the present invention and a display device driving method according to a conventional art. Through this function, a user can select the inventive driving mode or the conventional driving mode according to a characteristic of a moving picture that a user desires to watch.

The data control signal DCS may include a data start pulse STH, a data synchronous clock CPH, and a load signal TP, and the gate control signal GCS may include a gate start pulse STV and a gate synchronous clock CPH.

In more detail, the timing controller 150 stores the raw data RDATA that is externally input at a first driving frequency in the frame storing portion 170 in a frame unit, and synchronizes it with a second driving frequency before reading it. The timing controller 150 reads the first gamma information and the second gamma information corresponding to a raw data RDATA gray scale read out from the frame storing portion 170 with reference to the gamma storing portion 160, converts the first and second gamma information into the processing data PDATA, and synchronizes the PDATA with the second driving frequency before providing it to the data driver 120.

Here, the first driving frequency is a main clock frequency and the second driving frequency is a multiple frequency of the first driving frequency. For example, if the first driving frequency is 60 Hz and the second frequency is 120 Hz, one frame according to the first driving frequency is displayed on the display panel 110 as a sum of the first sub-frame and the second sub-frame by the second driving frequency. Therefore, the data control signal DCS and the gate control signal GCS may be generated and synchronized with the second driving frequency.

The gamma storing portion 160 stores gamma information having the first and second gamma information in a lookup table form. The first and second gamma information contain a plurality of gamma curve information. The gamma information of a lookup table form is described below in more detail with reference to Table 1.

The frame storing portion 170 stores the raw data RDATA that is externally input at the first driving frequency by the timing controller 150 in a frame unit.

The driving voltage generator 180 generates the gate on voltage VON and the gate off voltage VOFF and provides them to the gate driver 130. The driving voltage generator 180 generates the analog power voltage AVDD and the common voltage VCOM and provides them to the gamma voltage generator 140 and the display panel 100, respectively. The driving voltage generator 180 generates a digital power voltage DVDD to drive digital driving parts and provides it to the timing controller 150, the gate driver 130, and the data driver 120. The level of electric power supplied to each driver from the driving voltage generator 180 may be switched by the timing controller 150 or an externally input signal.

The display device 110 displays data on the display panel 110 using the first and second gamma information corresponding to the raw data RDATA gray scale. The first and second gamma information stored in the gamma storing portion 160 is described in more detail with reference to Table 1 and FIG. 7.

TABLE 1

| Gray scale | First gamma | Second gamma |
|---|---|---|
| group | information | information |
| GLG1 | FGC1 | SGC1 |
| GLG2 | FGC2 | SGC2 |
| GLG3 | FGC3 | SGC3 |
| . . . | . . . | . . . |
| GLGn | FGCn | SGCn |

Referring to Table 1 and FIG. 7, a gray scale group denotes a plurality of gray scale groups GLG1 to GLGN into which the entire gray scale (e.g., 64 gray scales, 256 gray scales, or 1024 gray scales), which can have the raw data RDATA, is grouped. The first gamma information includes gray scale voltage information according to a plurality of gamma curves FGC1 to FGCn shown in FIG. 7, which respectively correspond to a plurality of gray scale groups GLG1 to GLGn. The second gamma information includes gray scale voltage information according to a plurality of gamma curves SGC1 to SGCn of FIG. 7 that respectively correspond to a plurality of gray scale groups GLG1 to GLGn.

In Table 1, the first and second gamma information are represented as a collection of a plurality of gamma curves, but they are technically gray scale voltage digital information according to a gamma value of a corresponding gamma curve.

One gray scale group corresponds to the first gamma information and the second gamma information. Here, a gamma value of the gamma curve of the first gamma information is smaller than a gamma value of the gamma curve of the second gamma information corresponding to the first gamma information.

The first gamma information and the second gamma information do not have a single gamma value but instead have different gamma values according to gray scale group. That is, the first and second gamma information have discontinuous gamma values or discrete gamma values.

Therefore, the timing controller 150 reads out the first and second gamma information corresponding to the raw data RDATA through the gray scale group corresponding to the raw data RDATA with reference to the gamma storing portion 160, generates the processing data PDATA based on the first and second gamma information, and provides the processing data PDATA to the data driver 120.

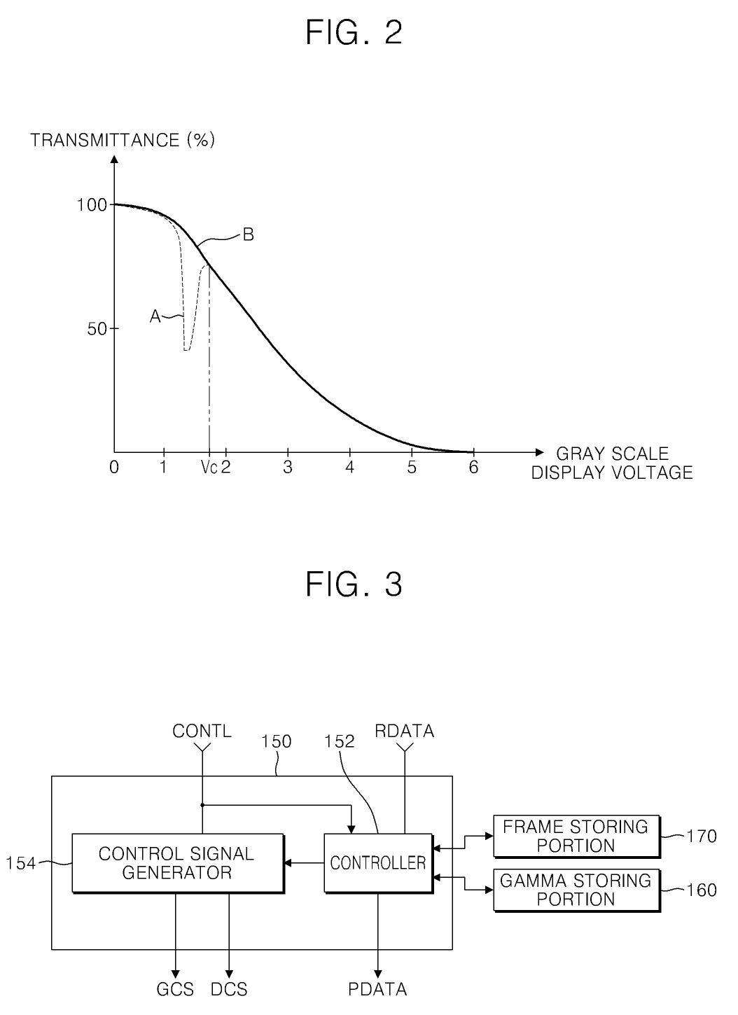

FIG. 2 is a graph showing a relationship of a gray scale display voltage and transmittance of the display device of FIG. 1. In the graph of FIG. 2, a dotted line curve A denotes a relationship of the gray scale display voltage and the transmittance in a typical OCB mode operation, and a solid line curve B denotes a relationship of the gray scale display voltage and the transmittance in an OCB mode operation according to the impulsive driving method.

Referring to the dotted line curve A, a bent state of liquid crystal is broken at a voltage lower than a threshold voltage Vc. Therefore, in the typical OCB mode operation, the display device displays a white gray scale through a white gray scale display voltage higher than a threshold voltage Vc (about 2 volts). That is, a gray scale display voltage applied to the display panel may be in the range of 2 volts to 6 volts.

Referring to the solid line curve B, in case of an OCB mode impulsive driving, unlike the typical OCB mode operation, it may be possible to display a normal white in a gray scale display voltage region lower than a threshold voltage Vc. Because the time until the bent alignment is broken is about 500 ms (corresponding to 30 frames), the liquid crystal can maintain a bent state during the whole driving period when an impulsive driving method is used in which a black gray scale display voltage higher than a threshold voltage Vc is applied at least one time per 1 hour period. According to the impulsive driving method of exemplary embodiments of the present invention, even a gray scale display voltage that is less than a threshold voltage Vc can be used as a white gray scale display voltage. Accordingly, a gray scale display voltage applied to the display panel may be in the range of 0 volts to 6 volts.

FIG. 3 is a block diagram showing the timing controller according to the exemplary embodiment of the present invention. As shown in FIG. 3, the timing controller includes a controller 152 and a control signal generator 154.

The controller 152 stores the externally input raw data RDATA in the frame storing portion 170 and reads out the raw data RDATA from the frame storing portion 170. In more detail, the controller 152 stores the raw data RDATA input at the first driving frequency into the frame storing portion 170, synchronizes the processing data PDATA generated based on the first gamma information stored in the gamma storing portion 160 with reference to the raw data RDATA with the second driving frequency, and provides the processing data PDATA to the data driver 120 during the first sub-frame period. The controller 152 synchronizes the processing data PDATA generated based on the second gamma information stored in the gamma storing portion 160 with reference to the raw data RDATA with the second driving frequency, and provides the processing data PDATA synchronized with the second driving frequency to the data driver 120 during the second sub-frame period.

The control signal generator 154 generates the gate control signal GCS and the data control signal DCS corresponding to the second driving frequency using the control signal CONTL corresponding to the first driving frequency under control of the controller 152, and provides the gate control signal GCS to the gate driver 130 and the data control signal DCS to the data driver 120.

Even though not described in detail, well-known interface techniques can be used to connect the timing controller 150 and an external graphics controller (not shown) or the timing controller 150 and the data driver 120.

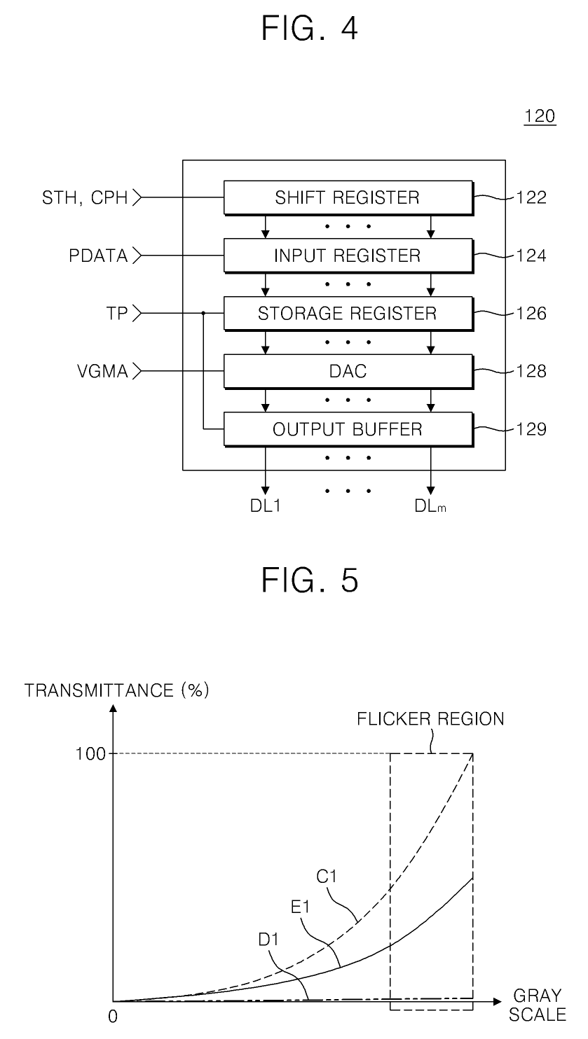

FIG. 4 is a block diagram showing the data driver according to an exemplary embodiment of the present invention. As shown in FIG. 4, the data driver 120 includes a shift register 122, an input register 124, a storage register 126, a digital-to-analog converter (DAC) 128, and an output buffer 129.

The shift register 122 receives the data start signal STH and the data synchronous clock CPH to generate a sampling signal and provides the sampling signal to the input register 124. In more detail, the shift register 122 shifts the data start signal STH per one period of the data synchronous clock CPH to generate m sampling signals.

The input register 124 sequentially stores the processing data PDATA in response to the sampling signals sequentially input from the shift register 122. In more detail, the input register 124 stores the processing data PDATA corresponding to a one line in response to the sampling signals.

The storage register 126 simultaneously receives and stores the processing data PDATA corresponding to the one line stored in the input register 124 when the load signal TP is input. Here, the load signal TP functions to have a gray scale display voltage corresponding to the processing data PDATA corresponding to the one line to be simultaneously applied to the pixel capacitors connected to one gate line.

The DAC 128 generates a gray scale display voltage corresponding to the processing data PDATA using the reference gamma voltage VGMA and provides it to the output buffer 129.

The output buffer 129 includes a plurality of amplifiers (not shown) to amplify gray scale display voltages supplied from the DAC 128 and provide them to the data lines DL1 to DLm. The amplifier may include a voltage follower.

The data driver of FIG. 4 may further include a level shifter arranged between the storage register 126 and the DAC 128 to convert a digital signal (i.e., processing data) stored in the storage register 126 into a signal of a level for operating the DAC 128.

FIG. 5 is a graph showing types of gamma curves to be stored in the gamma storing portion according to the exemplary embodiment of the present invention. In FIG. 5, a first gamma curve C1 denotes a data gamma curve applied to image data, and a second gamma curve D1 denotes an impulsive gamma curve for impulsive driving. Here, the second gamma curve D1 is zero in luminance over the whole gray scale period.

A gray scale display voltage to which a gamma value of the first gamma curve C1 is applied is provided to the display panel 110 during the first sub-frame period of one frame, and a gray scale display voltage to which a gamma value of the second gamma curve D1 is applied is provided to the display panel 110 during the second sub-frame period of one frame. Here, it is understood that a gray scale display voltage according to a gamma value of the first gamma curve C1 may be smaller than a threshold voltage Vc in the highest gray scale region. On the other hand, a bent state of the liquid crystal may be maintained and visibility of a moving picture may be improved when a gray scale display voltage according to a gamma value of the second gamma curve D1 is greater than a threshold voltage Vc in the highest gray scale region.

When these gamma curves are applied, since the luminance difference between the first gamma curve C1 and the second gamma curve D1 is large in a high gray scale region, i.e., flicker region, the luminance difference could be shown as a flicker.

In the graph of FIG. 5, “E1” denotes a display gamma curve displayed on the display panel by the first and second gamma curves C1 and D1. FIG. 5 is a case where it is assumed that a duty ratio defined as a ratio between a first sub-frame period time and a second sub-frame period time is 1:1. The location of the display gamma curve may change according to a duty ratio.

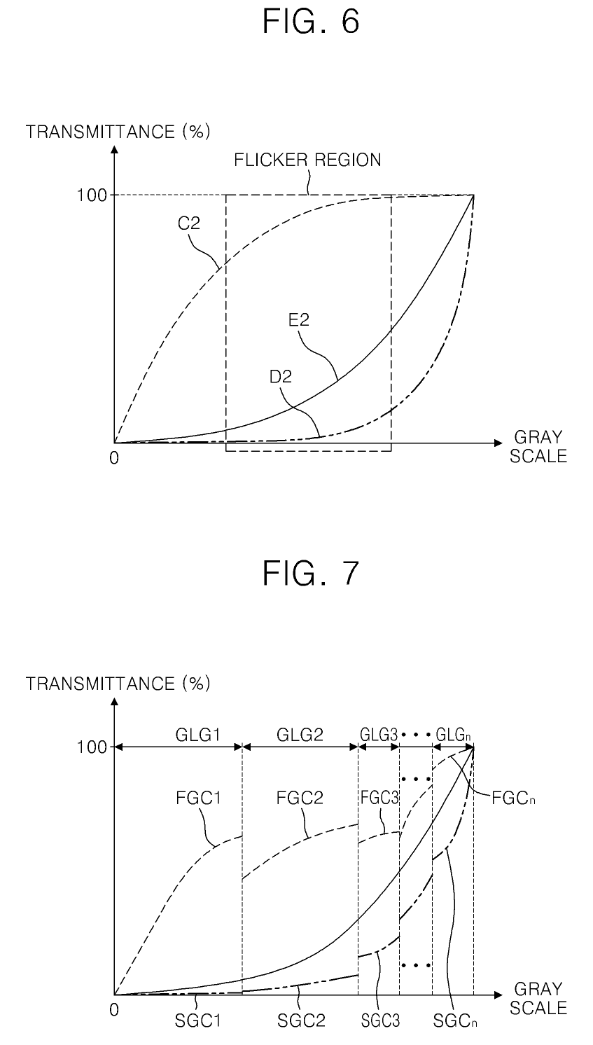

FIG. 6 is a graph showing another type of gamma curves to be stored in the gamma storing portion. Referring to FIG. 6, a first gamma curve C2 is a data gamma curve applied to image data, and a second gamma curve D2 is an impulsive gamma curve for impulsive driving.

The first gamma curve C2 is a gamma curve of high luminance, and the second gamma curve D2 is a gamma curve of low luminance. If a duty ratio is 1:1, an average of an arithmetical sum of the first and second gamma curves C2 and D2 corresponds to a display gamma curve E2. An average of an arithmetical sum of luminance of the first gamma curve C2 and luminance of the second gamma curve D2 corresponding to a certain gray scale is same as luminance of the display gamma curve E2 corresponding to a certain gray scale.

With both the first and second gamma curves C2 and D2, luminance is raised as the gray scale increases. In other words, when the gray scale increases, the luminance of the first gamma curve C2 rapidly increases in a low gray scale region but slowly increases in a high gray scale region, whereas the luminance of the second gamma curve D2 slowly increases in a low gray scale region but rapidly increases in a high gray scale region.

A gray scale display voltage, to which a gamma value of the first gamma curve C2 is applied, is provided to the display panel 110 during the first sub-frame period of one frame, and a gray scale display voltage to which a gamma value of the second gamma curve D2 is applied is provided to the display panel 110 during the second sub-frame period of one frame. In this instance, the first gamma curve C2 and the second gamma curve D2 meet with each other at the highest gray scale, and thus a bent state of the liquid crystal may be maintained and the visibility of a moving picture may be improved when both of a gray scale display voltage according to a gamma value of the first gamma curve C2 and a gray scale display voltage according to a gamma value of the second gamma curve D2 are greater than a threshold voltage Vc in the highest gray scale region.

Of course, a configuration that a gray scale display voltage according to a gamma value of the first gamma curve C2 is smaller greater than a threshold voltage Vc at a highest gray scale and a gray scale display voltage according to a gamma value of the second gamma curve D2 is greater than a threshold voltage Vc at a highest gray scale may be proposed. In this case, the two curves do not meet with each other at the highest gray scale.

When these gamma curves are applied, since a luminance difference between the first gamma curve C1 and the second gamma curve D1 is large in the high gray scale region, i.e., flicker region, the luminance difference could be shown as a flicker.

The gamma curves of FIG. 5 and FIG. 6 may be used to generate new gamma information. Hereinafter, an exemplary embodiment of the present invention is described by focusing on the new gamma information generated by using the type of gamma curve of FIG. 6.

FIG. 7 is a graph showing the new gamma information generated using the type of gamma curve shown in FIG. 6, which corresponds to Table 1. Referring to FIG. 7 and Table 1, gray scales corresponding to an X-axis of the gamma curve of FIG. 7 are grouped into a plurality of gray scale groups GLG1 to GLGn, and a display gamma curve is generated through an arithmetical sum of each first gamma curve FGC1 to FGCn and each second gamma curve SGC1 to SGCn, which are different for each gray scale group GLG1 to GLGn. Here, both of the gray scale display voltages according to the first gamma curves FGC1 to FGCn and the gray scale display voltages according to the second gamma curves SGC1 to SGCn are larger than a threshold voltage Vc in a highest gray scale region.

Of course, a configuration in which the gray scale display voltages according to the first gamma curves FGC1 to FGCn are smaller than a threshold voltage Vc in the highest gray scale region and the gray scale display voltages according to the second gamma curves SGC1 to SGCn are greater than a threshold voltage Vc in the highest gray scale region may be proposed. In this case, the two curves do not meet with each other at the highest gray scale.

In the display device according to an exemplary embodiment of the present invention, the first gamma information FGC1 to FGCn and the second gamma information SGC1 to SGCn have a discontinuous gamma value in a gray scale group (GLG1 to GLGn) unit.

The first gamma information (FGC2, FGC3, etc.) and the second gamma information (SGC2, SGC3, etc.), which correspond to a middle gray scale region (flicker region) and a high gray scale region of a region where a luminance difference between the first gamma curve C2 and the second gamma curve D2 shown in FIG. 6 is large may be selected to have a more reduced luminance difference than the luminance difference between the first gamma curve C2 and the second gamma curve D2 of FIG. 6.

Even when the first gamma curve C2 and the second gamma curve D2 of FIG. 6 correspond to a low gray scale region of FIG. 6, the luminance difference may be large and the degree to which a flicker is shown may be weak. Therefore, curves that are similar to the first gamma curve C2 and the second gamma curve D2 of FIG. 6 may be selected as the first gamma information FGC1 and the second gamma information SGC1.

If the gamma information of FIG. 7 is applied to the display device according to the exemplary embodiment of the present invention, a bent state of the liquid crystal may be maintained, the visibility of a moving picture may be improved, and the occurrence of a flicker problem in the middle gray scale region and the high gray scale region may be reduced.

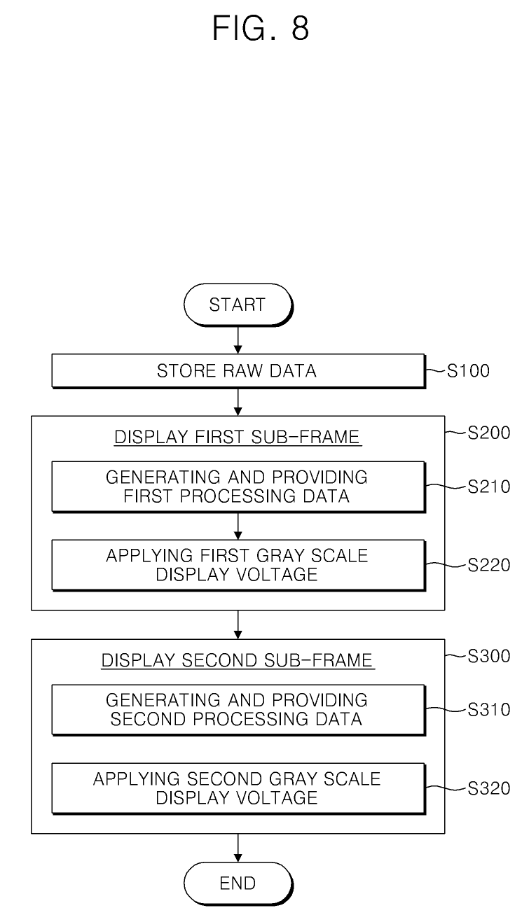

FIG. 8 is a flowchart showing a display device driving method according to an exemplary embodiment of the present invention. As shown in FIG. 8, the display device driving method according to the exemplary embodiment of the present invention includes storing raw data S100, displaying a first sub-frame S200, and displaying a second sub-frame S300.

Raw data is received through a graphics controller and stored in the frame storing portion S100. The first gray scale display voltage according to the first gamma curve is applied to the liquid crystal layer during the first sub-frame period S200. Then, the second gray scale display voltage according to the second gamma curve is applied to the liquid crystal layer during the second sub-frame period S300.

Displaying the first sub-frame S200 may include generating and processing data S210 and applying a first gray scale display voltage S220, and displaying the second sub-frame S300 may include generating and providing second processing data S310 and applying a second gray scale display voltage S320.

When generating and providing first processing data S210, the timing controller extracts information corresponding to each gray group among the first gamma information stored in the gamma storing portion with reference to gray scale information of the raw data stored in the frame storing portion and generates the processing data and provides the processing data to the data driver.

When applying the first gray scale display voltage S220, the data driver receives the processing data and generates the first gray scale display voltage with reference to the reference gamma voltage transmitted from the gray scale voltage generator and applies the first gray scale display voltage to the pixel capacitor of the display panel.

When generating and providing the second processing data S310, the timing controller extracts information corresponding to each gray group among the second gamma information stored in the gamma storing portion with reference to gray scale information of the raw data stored in the frame storing portion and generates the processing data and provides the processing data to the data driver.

When applying the second gray scale display voltage S320, the data driver receives the processing data and generates the second gray scale display voltage with reference to the reference gamma voltage transmitted from the gray scale voltage generator and applies the second gray scale display voltage to the pixel capacitor of the display panel.

At this time, as shown in Table 1 and FIG. 7, the first gamma curve (information) and the second gamma curve (information) have discontinuous points between the gray scale groups. There is a distance between the two curves in the middle gray scale region and the high gray scale region in order to prevent a flicker phenomenon. To this end, a left limit value of a lowest gray scale discontinuous point is larger than a right limit value thereof.

Displaying the first sub-frame S200 and displaying the second sub-frame S300 are sequentially performed, and storing the raw data S100 to display the next frame may be simultaneously performed.

In one frame, a duty ratio, which is a ratio between the first sub-frame period and the second sub-frame period, may be 1:1. Alternatively, a duty ratio of 2:8 or 4:6, in which the first sub-frame period is shorter than the second sub-frame period, are also possible. Of course, a duty ratio of 6:4 or 8:2, in which the first sub-frame period is longer than the second sub-frame period, is also possible. A duty ratio may be selected in consideration of a trade off relation between an impulsive driving effect and a luminance decreasing effect.

As described above, according to the display device and the display device driving method of the present invention, since the display device can be driven in an impulsive driving method using different gamma curves according to a data gray scale, a flicker due to a transmittance difference between the first gamma curve and the second gamma curve may be efficiently prevented.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A display device driving method, comprising:
applying a first gray scale display voltage according to a first gamma curve to a liquid crystal layer during a first sub-frame period; and
applying a second gray scale display voltage according to a second gamma curve to the liquid crystal layer during a second sub-frame period,
wherein the first gamma curve and the second gamma curve are discontinuous at one or more gray scale values among all gray scale regions.

2. The display device driving method of claim 1, wherein at the same gray scale, a luminance value of the first gamma curve is greater than a luminance value of the second gamma curve.

3. The display device driving method of claim 2, wherein a left limit value is greater than a right limit value in a lowest gray scale discontinuous point of the first gamma curve.

4. The display device driving method of claim 3, wherein the display device comprises:
a first substrate having a first polarizer plate; and
a second substrate having a second polarizer plate,
wherein the liquid crystal layer is interposed between the first substrate and the second substrate, and
wherein polarization axes of the first polarizer plate and the second polarizer plate are substantially perpendicular to each other, a rubbing direction of the first substrate and a rubbing direction of the second substrate are the same and form an angle of about 35° to about 55° or about 125° to about 145° with the polarization axis of the first polarizer plate, liquid crystal of the liquid crystal layer has positive dielectric constant anisotropy, and a highest gray scale display voltage according to the second gamma curve is greater than a bending alignment threshold voltage of the liquid crystal layer.

5. The display device driving method of claim 4, wherein a highest gray scale display voltage according to the first gamma curve is smaller than the bending alignment threshold voltage of the liquid crystal layer.

6. The display device driving method of claim 3, wherein the display device comprises:
a first substrate having a first polarizer plate; and
a second substrate having a second polarizer plate,
wherein the liquid crystal layer is interposed between the first substrate and the second substrate, and
wherein polarization axes of the first polarizer plate and the second polarizer plate are perpendicular to each other, and the liquid crystal layer comprises liquid crystal that is vertically aligned in the absence of an electric field and has negative dielectric constant anisotropy.

7. A display device, comprising:
a frame storing portion to receive and store raw data input at a first driving frequency;
a gamma storing portion to store first gamma information and second gamma information;
a timing controller to generate processing data based on the raw data stored in the frame storing portion and the first gamma information and the second gamma information stored in the gamma storing portion; and
a data driver to receive the processing data from the timing controller and apply a gray scale display voltage to a pixel capacitor of a display panel,
wherein a first gamma curve corresponding to the first gamma information and a second gamma curve corresponding to the second gamma information are discontinuous at one or more gray scale values among all gray scale regions, and
wherein the timing controller synchronizes the processing data according to the first gamma information with a second driving frequency during a first sub-frame period and synchronizes the processing data according to the second gamma information with the second driving frequency during a second sub-frame period.

8. The display device of claim 7, wherein at the same gray scale, a luminance value according to the first gamma curve is greater than a luminance value according to the second gamma curve.

9. The display device of claim 8, wherein a left limit value is greater than a right limit value in a lowest gray scale discontinuous point of the first gamma curve.

10. The display device of claim 9, further comprising:
a first substrate having a first polarizer plate; and
a second substrate having a second polarizer plate,
wherein a liquid crystal layer is interposed between the first substrate and the second substrate, and
wherein polarization axes of the first polarizer plate and the second polarizer plates are perpendicular to each other, a rubbing direction of the first substrate and a rubbing direction of the second substrate are the same and form an angle of about 35° to about 55° or about 125° to about 145° with the polarization axes, the liquid crystal layer includes liquid crystal having positive dielectric constant anisotropy, and a highest gray scale display voltage according to the second gamma curve is greater than a bending alignment threshold voltage of the liquid crystal layer.

11. The display device of claim 10, wherein a highest gray scale display voltage according to the first gamma curve is smaller than a bending alignment threshold voltage of the liquid crystal layer.

12. The display device of claim 9, further comprising:
a first substrate having a first polarizer plate; and
a second substrate having a second polarizer plate,
wherein the liquid crystal layer is interposed between the first substrate and the second substrate, and
wherein polarization axes of the first polarizer plate and the second polarizer plate are perpendicular to each other, and the liquid crystal layer comprises liquid crystal that is vertically aligned in the absence of an electric field and has negative dielectric constant anisotropy.
